(19) United States
(12) Patent Application Publication
(10) Pub. No.: US 2011/0278411 A1
(43) Pub. Date: Nov. 17, 2011

(54) MOUNTING FOOT FOR SOLAR MODULES AND MOUNTING SYSTEM HAVING A PLURALITY OF SUCH MOUNTING FEET

(75) Inventors: Martin Carbonare, Koblach (AT); Elio Bragagna, Duens (AT)

(73) Assignee: Hilti Aktiengesellschaft, Schaan (LI)

(21) Appl. No.: 13/108,771

(22) Filed: May 16, 2011

(30) Foreign Application Priority Data
May 17, 2010 (DE) 10 2010 029 002.5

(51) Int. Cl. E04D 13/18; B23P 11/00

(52) U.S. Cl. 248/237; 29/428

(57) ABSTRACT

A mounting foot for solar modules is disclosed. The mounting foot includes a base body having at least one stand space with which the mounting foot can be supported on a substrate, an upper support connected to the base body for a first inclined modular panel and a lower support connected to the base body for a second inclined modular panel not coplanar with the first modular panel. The upper support is at a greater distance from a plane spanned by the stand space than is the lower support. Also disclosed is a mounting system having a plurality of such mounting feet and a mounting method.

This application claims the priority of German Patent Document No. 10 2010 029 002.5, filed May 17, 2010, the disclosure of which is expressly incorporated by reference herein.

### BACKGROUND AND SUMMARY OF THE INVENTION

The invention relates to a mounting foot for solar modules and a mounting system, in particular a flat roof mounting system for solar modules having such mounting feet.

Solar installations are experiencing growing popularity today for both economic and ecological reasons in view of rising energy costs, a variety of funding programs for regenerative energies and current discussions about the consequences of a global climate change. Owners of real estate suitable for solar installations are always attempting to achieve the maximum energy yield at the lowest possible investment in solar modules and a “solar-compliant” renovation of the building.

It has been found that flat roofs are especially suitable for use by solar installations because usually only minimal structural adjustments to the building itself are necessary or none at all. As a substructure usually only a mounting system is installed, so that the solar modules can be positioned obliquely to face south, thereby significantly increasing the efficiency and therefore also the energy yield of the solar installation.

To prevent damage to the roofing membrane and the sensitive roof seal on flat roofs, this mounting system is usually installed without establishing a direct attachment or connection to the building. The mounting system is secured against displacement or lifting via ballast, but the maximal supporting load of the flat roof must be taken into account. The mounting system, which serves as an understructure, thus forms a roof attachment onto which the solar modules are secured at a desired angle of inclination.

Since the supporting load of roofs is limited, measures for ballast reduction have already been described in the prior art, these measures are already being implemented in various ways in the mounting systems customary today.

Measures known from the prior art include, for example, connecting elements which connect individual solar modules or rows of solar modules of the solar installation to form a large unit to prevent unwanted shifting of the solar modules when wind loads occur. Furthermore, it is quite customary to use wind deflectors to reduce the lifting forces acting on the solar modules.

The object of the present invention is to create a mounting foot and a mounting system for solar modules that can be manufactured as easily and economically as possible, that can be installed on a substrate at little cost on the one hand and can be connected to form a large unit as well as enabling simple mounting of the solar modules on the other hand.

This object is achieved according to the present invention by a mounting foot for solar modules having a base body, which has at least one stand space, with which the mounting foot can be supported on a substrate, an upper support connected to the base body for a first inclined modular panel and a lower support connected to the base body for a neighboring, second modular panel, which is inclined but is not coplanar with the first modular panel, such that the upper support is at a greater distance than the lower support from a plane spanned by the stand space.

In its main function as a solar module carrier, the mounting foot has height-adjustable supports for up to four modular panels. In addition, the mounting foot also has a connecting function between two rows of solar modules, so that a mounting system having a plurality of such mounting feet can be connected with minimal effort to form a modular unit and consequently no unwanted shifting of individual solar modules or individual rows of solar modules is possible.

Several neighboring modular panels, which are aligned essentially coplanarly, i.e., essentially lie in one plane, are referred to as a row of solar modules. In contrast with that, the modular panels of different rows of solar modules are not coplanarly arranged and lie in different planes although they are usually parallel. The mounting feet may be used universally and are not limited to certain modular panel dimensions.

In one embodiment of the mounting foot, at least one of the supports is arranged on the free end of a leg protruding upward from the base body. The simple support construction by a support leg enables simple adjustment of the mounting foot from the standpoint of manufacturing technology, e.g., at a desired angle of inclination of the solar modules.

The leg preferably forms an acute angle with the stand space. This so-called setting angle is especially preferably in the range of 50° to 80° to rapidly achieve the desired height for the respective support on the one hand while on the other hand reducing the dynamic pressure occurring in a plane spanned by the stand space to an acceptable extent when there is wind, thereby preventing any displacement of the mounting foot in this plane. A suitable setting angle of the leg then is especially advantageous when a wind deflector, for example, is attached to the leg and thus essentially has the same setting angle.

The leg with the upper support comprises a bearing section for a wind deflector and/or a ballast element in another embodiment of the mounting foot. With mounting of a wind deflector on the leg of the upper support, the setting angle of the leg and that of the wind deflector are usually essentially identical. The choice of the setting angle between the leg and the stand space is therefore especially important for the bearing forces that occur under a wind load. It is readily possible to adjust this angle in manufacturing the mounting foot with little effort in terms of manufacturing technology.

The leg of the upper support may in particular have a bearing section for neighboring wind deflectors and/or ballast elements on each of its opposing sides in the transverse direction. In this case this yields a grid measure for the wind deflectors and/or ballast elements, this grid measure corresponding especially advantageously to that of the solar modules. In the transverse direction multiple successive coplanar modular panels are arranged, with two mounting feet being arranged between two neighboring modular panels. The one mounting foot forms two supports for the upper corner area of the modular panels and the other mounting foot forms two supports for the lower corner area of the neighboring modular panels so that the grid measure of the mounting feet in the transverse direction is defined by their length or width depending on the direction of installation of the modular panels. If the mounting foot serves at the same time as a bearing for two wind deflectors and/or ballast elements near one another in the transverse direction, this simplifies the installation of the mounting system substantially. The grid predefined by the modular panels is then identical to the grid or a multiple of the grid of the wind deflectors and/or ballast elements, which makes it superfluous to tailor them to the construction site.

The lower support of the mounting foot is preferably a fork bearing for holding one edge of the modular panel. Such a fork bearing permits bearing support of modular panels whose panel thickness and/or angle of inclination varies within a predetermined range. Thus identical mounting feet may be used for different angles of inclination and/or modular panels of different dimensions. The mounting foot can thus be used universally and need only be adapted structurally for unusual dimensions of the modular panels and/or unusual angles of inclination.

The base body of the mounting foot preferably has a fastening section for a longitudinal connecting strut between mounting feet arranged one after the other in a longitudinal direction. After completion of the solar installation, these struts extend beneath a modular panel. Depending on the bearing and load-bearing capacity of the modular panels with respect to tension or pressure, the longitudinal connecting struts may either be omitted, designed merely as thin tie rods or as more solid tension profiles and pressure profiles. Moreover, the mounting system can be adapted with little effort to module dimensions which vary greatly in longitudinal direction by simply replacing the longitudinal connecting struts.

In another embodiment of the mounting foot for solar modules, the base body comprises a first base body section with one leg having the upper support, a second base body section with one leg having the lower support and a connecting web between the base body sections, so that the stand space is interrupted in the area of the connecting web. A reduction in the stand space in the area of the connecting web has a positive effect on the standing security of the mounting foot when the substrate is very uneven locally because it is less susceptible to tilting. Furthermore, the interrupted stand space allows installation of lines and cables directly on the substrate, beneath the connecting web in the transverse direction. Due to the installation on the substrate, so-called “stumbling blocks” are prevented and the risk of damage to the lines or cables is minimized.

In an especially preferred embodiment, the mounting foot is a one-piece aluminum part, in particular a cast aluminum part. However, the use of plastics or steel is also possible. Manufacturing this from plastic thus has a positive effect on the mounting system with respect to the cost of materials and also with respect to manufacturing costs. Suitable plastics, in particular fiber-reinforced plastics having the required mechanical load-bearing capacity, endurance and weather resistance are already obtainable at a comparatively low cost. Furthermore, these plastics can usually be processed well, so that even complex geometric shapes can be manufactured at a relatively low cost.

The problem formulated here is also solved by a mounting system, in particular a flat roof mounting system for solar modules having a plurality of the mounting feet arranged one after the other in a longitudinal direction, as described above in order to support a front edge of a modular panel on the lower support of a front mounting foot and a rear edge of the modular panel on the upper support of a rear mounting foot, at least one longitudinal connecting strut for connecting two neighboring mounting feet in the longitudinal direction and/or at least one cross-connecting strut for connecting two neighboring mounting feet in a transverse direction.

The mounting system described here is consequently designed to be very easily and universally usable and can be connected to a unit with little effort so that even with a wind load an unwanted shifting of individual system sections, for example, a solar module row is largely ruled out.

Preferably a fastening device is provided between the mounting foot and a longitudinal connecting strut, enabling locking of the mounting foot and the longitudinal connecting strut in the longitudinal direction in different positions to thereby adjust different spacing of successive mounting feet. This makes it possible to equalize tolerances or minor differences in the module dimensions of different solar module manufacturers without having to change the system components.

In particular the fastening device may have locking geometries on the mounting foot and/or on the longitudinal connecting strut. The locking geometries permit rapid locking of the mounting foot and the longitudinal connecting strut in the longitudinal direction, so that the installation and alignment of the mounting system are simplified. Furthermore, due to the locking geometries, locking in the longitudinal direction is retained even when additional connecting elements such as screws or clamps become loosened.

Moreover a stop is preferably provided between the mounting foot and the longitudinal connecting strut, such that the stop limits an angle-adjusting range about a middle position in which the longitudinal connecting strut runs parallel to the stand space. Therefore unevenness or a change in gradient of the substrate, for example, which occurs due to drainage reasons can be compensated with no problem.

Additional features and advantages of the invention are derived from the following description of a preferred embodiment with reference to the drawings.

### BRIEF DESCRIPTION OF THE DRAWINGS

FIG. 1 shows a perspective view of an inventive mounting foot for solar modules;

FIG. 2 shows a perspective view of a solar installation with an inventive mounting system having a plurality of inventive mounting feet;

FIG. 3 shows a detail of an inventive mounting system for solar modules in a perspective view;

FIG. 4 shows a detailed view of the inventive mounting system in the connecting area between the base body and the longitudinal connecting strut;

FIG. 5 shows the detailed view according to FIG. 4 without the longitudinal connecting strut; and

FIG. 6 shows a detailed view of the inventive mounting system in the area of a rear end.

### DETAILED DESCRIPTION OF THE DRAWINGS

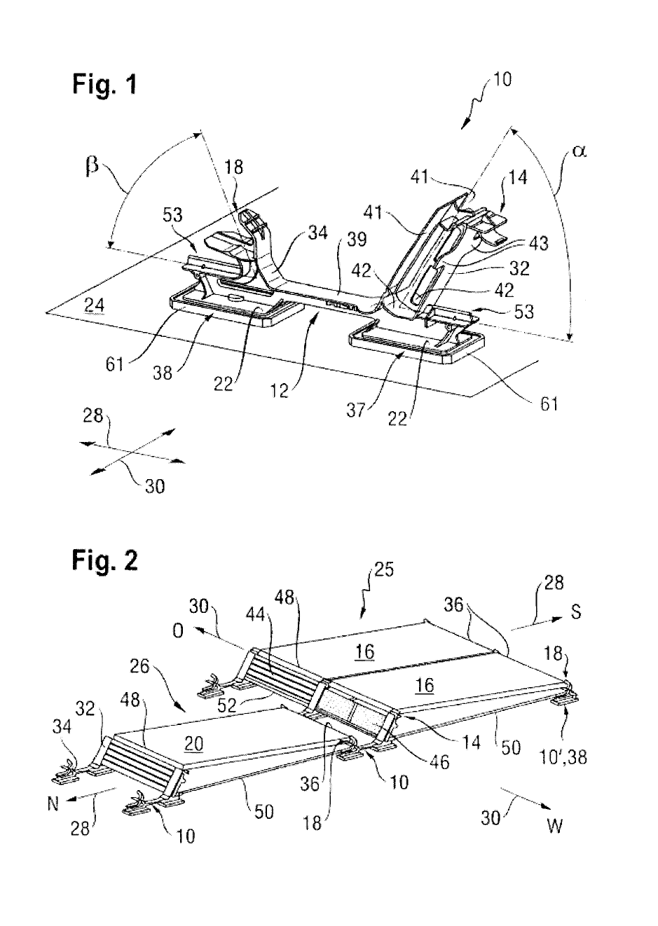

FIGS. 1 and 2 show a mounting foot 10 for solar modules having a base body 12, an upper support 14 for a first inclined modular panel 16, the support being connected in one piece to the base body 12, and a lower support 18 for a neighboring second inclined modular panel 20, which is not coplanar with the first modular panel 16, the supports being connected in one piece to the base body 12. The base body 12 has at least one stand space 22 with which the mounting foot 10 can be supported on a substrate 24 such as a roofing membrane of a flat roof. The upper support 14 is at a greater distance from a plane spanned by the stand space 22 than the lower support 18.

To illustrate the function and use of such a mounting foot 10 as well as the difference between first and second modular panels 16, 20, FIG. 2 shows a detail of a solar installation 25 having a mounting system 26 for solar modules such that the present mounting system 26 is a flat room mounting system with a corresponding horizontal substrate 24 and has a plurality of mounting feet 10 according to FIG. 1. The mounting system 26 together with the solar modules designed as modular panels 16, 20 forms the solar installation 25. In addition to flat roofs, use of the mounting system 26 on monopitch roofs with a low roof inclination or another substrate 24 with a low inclination is also conceivable.

The mounting system 26 comprises a plurality of solar modules inclined or obliquely positioned in relation to a plane spanned by the stand space 22, the solar modules being divided into two solar modules rows according to FIG. 2 with first modular panels 16 and second modular panels 20, but FIG. 2 shows only a second modular panel 20. All modular panels 16, 20 which are arranged in coplanar installation, i.e., all situated in one plane, are referred to as a solar module row here. However, the modular panels 16, 20 of two different solar module rows are not arranged coplanarly and are situated accordingly in different planes although they are at least essentially parallel.

The inclined position, i.e., inclination of the solar modules, is usually such that a top side of the solar modules is facing south. An inclination direction of the solar modules is defined below as the longitudinal direction 28 of the mounting system 26, so that the longitudinal direction 28 of a finished solar installation 25 according to FIG. 2 usually corresponds to the north-south direction. Accordingly, a solar module row extends in a transverse direction 30, which usually corresponds to the east-west direction.

With reference to the mounting foot 10 according to FIG. 1, the upper support 14 as well as the lower support 18 are arranged on the free end of a leg 32, 34 protruding upward from the base body 12 according to FIG. 1.

In the present exemplary embodiment, the free end of the leg 34 is designed with the lower support 18 as a fork bearing to receive a front edge 36 (as seen from the south) of the modular panel 16, 20 (see also FIG. 2). The fork bearing is embodied so that it allows a limited pivoting of the modular panel 16, 20 about the lower support 18 so that the mounting foot 10 can be used in an embodiment of the same design for different angles of inclination of the solar modules.

According to FIG. 1, the two legs 32, 34 for the supports 14, 18 each form an acute angle α, β with the stand space 22, such that the legs 32, 34 are each directed away from one another in the longitudinal direction 28.

The leg 32 on the upper support 14 in particular is directed away from the leg 34 and forms an acute angle a (setting angle), i.e., an angle of 0°<α<90° with the stand space 22. Because of the dynamic pressure occurring with a wind burden, the setting angle a of the leg 32 is preferably between 50° and 80°. Angles of attack α≧90° are conceivable in principle but are reasonable only in special exceptional cases for the reasons given above.

The leg 34 of the lower support 18 is usually so short that its setting angle β does not have any significant influence on the mounting system 26. Therefore the setting angle β of the leg 34 drawn in FIG. 1 may also assume values of β≧90°.

The base body 12 of the mounting foot 10 according to FIG. 1 comprises a first base body section 37 with the leg 32, a second base body section 38 with the leg 34 and a connecting web 39 between the base body sections 37, 38 such that the stand space 22 is interrupted in the area of the connecting web 39. In other words, there are two stand spaces 22, which are advantageously arranged directly at the load induction points of the legs 32, 34 of the mounting foot 10, thereby ensuring safe transfer of the load into the substrate 24. In comparison with a single large stand space 22, this embodiment offers the advantage of a greater standing security due to a lower tilting tendency with a substrate 24 that is very uneven locally.

Furthermore, the interrupted stand space 22 allows installation of lines and cables in the transverse direction 30 directly on the substrate 24 beneath the connecting web 39. This minimizes the risk of damage to the lines or cables.

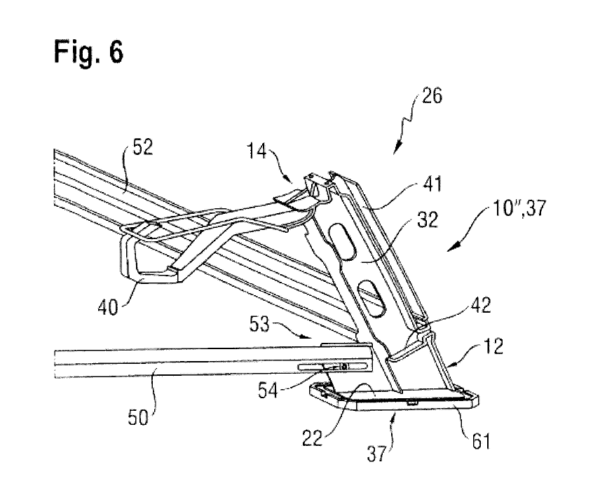

In an alternative embodiment variant according to FIG. 6, the lines and cables are installed in the transverse direction 30 in a cable duct (not shown) which is attached by a cable duct holder 40 to the free end of the leg 32. The lines and cables in this case are protected beneath the solar modules after completion of the solar installation 25.

According to FIG. 1, bearing sections 41, 42, 43 for a wind deflector 44 and a ballast element 46 (see FIG. 2) can be seen on the leg 32 of the upper support 14. The bearing section 41 for the wind deflector 44 is a groove that can extend in the longitudinal direction of the leg 32 and can hold the lateral ends of the wind deflector 44. A setting angle of the wind deflector 44 thus corresponds to the setting angle α of the leg 32 with the upper support 14. The bearing sections 42, 43 for the ballast element 46 are designed as a supporting surface in the transitional area between the base body 12 and the leg 32 and/or as a laterally protruding bearing tongue on the leg 32. The bearing sections 42, 43 are arranged so that a setting angle of the plate-shaped ballast elements 46 corresponds essentially to the setting angle α of the leg 32 with the upper support 14.

FIGS. 1 and 2 also show that, when seen in the transverse direction 30, not only two modular panels 16, 20 but also two wind deflectors 44 and two ballast element 46 are adjacent to one another on the mounting foot 10. Consequently, the leg 32 of the upper support 14 has bearing sections 41, 42, 43 for neighboring wind deflectors 44 and ballast elements 46 on its opposite sides in the transverse direction 30.

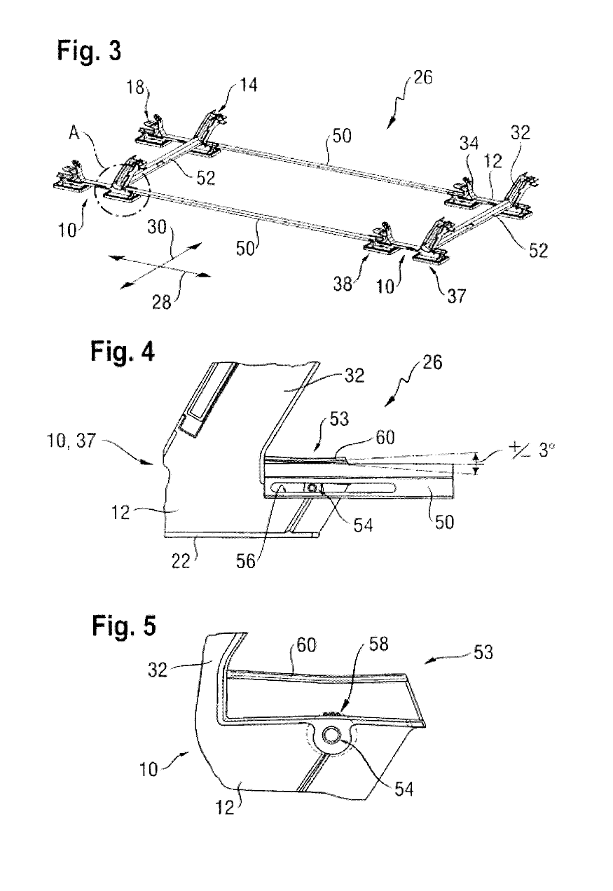

The mounting system 26 in FIG. 2 has, as already mentioned, a plurality of mounting feet 10 arranged one after the other in the longitudinal direction 28 in order to support the front edge 36 of a modular panel 16, 20 on the lower support 18 of a front mounting foot 10 and a rear edge 48 of this modular panel 16, 20 on the upper support 14 of a rear mounting foot 10. In addition, the mounting system 26 comprises longitudinal connecting struts 50 for connecting two mounting feet 10 that are adjacent in the longitudinal direction 28 and transverse connecting struts 52 for connecting two mounting feet 10 that are adjacent in the transverse direction 30. This basic system design can also be seen in particular in FIG. 3, where a detail of the mounting system 26 is shown. The longitudinal connecting struts 50 are preferably made of plastic but as an alternative may also be metal struts. However, the transverse connecting struts 52 are preferably metal struts in particular when they serve as supports for the ballast elements 46. Alternatively, however, transverse connecting struts 52 made of plastic are also conceivable.

The transverse connecting struts 52 are preferably designed in the form of troughs and extend between two neighboring mounting feet 10 such that the ends of each transverse connecting strut 52 are attached to the mounting feet 10. According to FIG. 3, the ends of the transverse connecting strut 52 are inserted into recesses in the leg 32 and are also situated in the transitional area between the base body 12 and the leg 32 on the bearing section 42 which is also designed like a trough (see also FIG. 6).

The individual mounting feet 10 according to FIG. 1 each have height-offset supports 14, 18 for up to four modular panels 16, 20, only one or two supports 14, 18 being used in the corner areas and edge areas of the mounting system 26. Suitably adjusted mounting feet 10′ consists essentially only of the second base body section 38 of which the lower support 18 is used in particular on the front end of the mounting system 26 as seen from the south (see FIG. 2). To also be able to secure these adjusted mounting feet 10′ in the transverse direction 30, the bearing section 42 here is designed to receive a transverse connecting strut 52 in the transitional area between the base body 12 and the leg 34 of the lower support 18 as an exception. Adapted mounting feet 10″ consists essentially only of the first base body section 37 of which the upper support 14 may also be used on the rear end of the mounting system 26 (see FIG. 6).

FIG. 4 shows a detailed view A of the mounting system 26 in a connecting area between the mounting foot 10 and the longitudinal connecting strut 50, such that this connecting area is circled with a dash-dot line for orientation purposes in FIG. 3. In conjunction with FIG. 1, it is clear that the base body 12 of the mounting foot 10 has a fastening section 53 for a longitudinal connecting strut 50 on its opposite ends in the longitudinal direction 28.

To be able to adjust different spacing of mounting feet 10 arranged in succession, a fastening device 54 which allows locking of mounting foot 10 and longitudinal connecting strut 50 in the longitudinal direction 28 in different positions is provided between the longitudinal connecting strut 50 and the base body 12. The fastening device 54 in the present case comprises a screw, which cooperates with an elongated hole 56 in the longitudinal connecting strut 50 to enable variable locking in the longitudinal direction 28.

FIG. 5 shows a detailed view according to FIG. 4, but without the longitudinal connecting strut 50. Therefore the fastening section 53 of the base body 12 can be seen in detail and it is readily recognizable that the fastening device 54 has locking geometries 58 on the mounting foot 10. These locking geometries 58 preferably cooperate with suitable locking geometries (not shown) on the longitudinal connecting strut 50 so that numerous different locking engagements are formed via longitudinally displaceable connection between the mounting foot 10 and the longitudinal connecting strut 50. These locking engagements ensure locking in the longitudinal direction 28, even without a screw connection, so that the mounting system 26 can be aligned with little effort. The locking which is already present is then merely secured by the cooperating locking geometries 58 by additional insertion and tightening of the screw. Moreover, due to the locking geometries 58 a certain locking in the longitudinal direction 28 is also ensured when individual screws of the fastening device 54 become loosened over a period of time.

Furthermore, a stop 60 is provided between the mounting foot 10 and the longitudinal connecting strut 50, such that the stop 60 borders an angle adjusting range about a middle position in which the longitudinal connecting strut 50 runs parallel to the stand space 22. In the present exemplary embodiment this stop 60 is embodied on the mounting foot 10 (see FIG. 5) and has an angle adjusting range of the order of magnitude of approximately ±3° about the middle position (see also FIG. 4). Unevenness and changes in gradient of the substrate 24 for drainage reasons, for example, can be compensated by this angle adjusting range.

Since the mounting system 26 is subject to great temperature fluctuations and usually reaches dimensions of several meters in both the longitudinal direction 28 and in the transverse direction 30, the strains that occur due to thermal changes are substantial. In order to prevent these temperature-induced changes from leading to stresses of an undesirable extent within the mounting system 26, mounting feet 10 arranged more or less in the middle in the longitudinal direction 28 and/or in the transverse direction 30, for example, in a plane spanned by their stand spaces 22 may be designed as fixed bearings and the other mounting feet 10 in this plane may be designed as sliding bearings, for example. For this purpose preferably sliding shoes 61 are provided as indicated in FIGS. 1 and 6 so that the mounting feet 10 are supported on the substrate 24 by way of their stand space 22, optional sliding inserts and the sliding shoe 61.

The mounting foot 10 is preferably manufactured in one piece of aluminum, in particular as a cast aluminum part. Alternatively, it is of course also possible to use plastic, in particular fiber-reinforced plastic or steel. Relatively complex geometric shapes such as the mounting foot 10 can be manufactured from plastics with relatively little complexity. Furthermore, plastics suitable for the mounting foot 10 and having adequate strength, endurance and weather resistance are available at comparatively low price so that the mounting foot 10 can be manufactured very inexpensively on the whole. Alternatively, it is of course also conceivable to have a multipart production of the mounting foot 10.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A mounting foot for solar modules, comprising
a base body having a stand space;
an upper support connected to the base body; and
a lower support connected to the base body;
wherein the upper support is at a greater distance than the lower support from a plane spanned by the stand space.

2. The mounting foot according to claim 1, wherein at least one of the upper support and the lower support is arranged on a free end of a leg protruding upward from the base body.

3. The mounting foot according to claim 2, wherein the leg forms an acute angle with the stand space.

4. The mounting foot according to claim 2, wherein the leg has a bearing section.

5. The mounting foot according to claim 2, wherein the leg has a first bearing section and a second bearing section and wherein the first and second bearing sections are disposed on opposite sides of the leg in a transverse direction.

6. The mounting foot according to claim 1, wherein the lower support is a fork bearing.

7. The mounting foot according to claim 1, further comprising a longitudinal connecting strut and wherein the longitudinal connecting strut is receivable within a fastening section of the base body.

8. The mounting foot according to claim 1, wherein the base body has a first base body section with a first leg having the upper support, a second base body section with a second leg having the lower support, and a connecting web extending between the first base body section and the second base body section such that the stand space is interrupted in an area of the connecting web.

9. The mounting foot according to claim 1, wherein the mounting foot is a one-piece aluminum part.

10. A mounting system for solar modules, comprising:
a plurality of mounting feet, wherein each of the plurality of mounting feet comprises:
a base body having a stand space;
an upper support connected to the base body; and
a lower support connected to the base body;
wherein the upper support is at a greater distance than the lower support from a plane spanned by the stand space;
a longitudinal connecting strut, wherein the longitudinal connecting strut connects two neighboring mounting feet in a longitudinal direction; and/or
a transverse connecting strut, wherein the transverse connecting strut connects two neighboring mounting feet in a transverse direction.

11. The mounting system according to claim 10, further comprising a fastening device provided between a one of the two neighboring mounting feet in the longitudinal direction and the longitudinal connecting strut such that the one of the two neighboring mounting feet in the longitudinal direction and the longitudinal connecting strut are lockable in different positions in the longitudinal direction such that a spacing of the two neighboring mounting feet in the longitudinal direction is adjustable.

12. The mounting system according to claim 11, wherein the fastening device includes a locking geometry.

13. The mounting system according to claim 10, further comprising a stop provided between a one of the two neighboring mounting feet in the longitudinal direction and the longitudinal connecting strut such that the stop limits an angle adjusting range of the longitudinal connecting strut.

14. A method of mounting solar modules, comprising the steps of:
supporting a mounting foot on a substrate, wherein the mounting foot includes a base body having a stand space;
supporting a first solar module in an upper support connected to the base body; and
supporting a second solar module in a lower support connected to the base body;
wherein the upper support is at a greater distance than the lower support from a plane spanned by the stand space.

15. The method according to claim 14, wherein the first solar module is not co-planar with the second solar module.

16. The method according to claim 14, wherein the first solar module and the second solar module are inclined with respect to the plane spanned by the stand space.
